(19) United States
(12) Patent Application Publication
(10) Pub. No.: US 2022/0319536 A1
(43) Pub. Date: Oct. 6, 2022

(54) EMOTION RECOGNITION METHOD AND EMOTION RECOGNITION DEVICE USING SAME

(71) Applicant: LOOXID LABS INC., Daejeon (KR)

(72) Inventor: Hong Gu LEE, Seoul (KR)

(73) Assignee: LOOXID LABS INC., Daejeon (KR)

(21) Appl. No.: 17/617,932

(22) PCT Filed: Feb. 17, 2020
(86) PCT No.: PCT/KR2020/002226

§ 371 Date: Dec. 10, 2021

(30) Foreign Application Priority Data
Jun. 11, 2019 (KR) 10-2019-0068477

(51) Int. Cl. G10L 25/63; G06F 3/01

(52) U.S. Cl. CPC G10L 25/63; G06F 3/013; G06F 3/015

(57) ABSTRACT

The present invention relates to an emotion recognition method implemented by a processor. Provided are an emotion recognition method and a device using the same, the emotion recognition method comprising: providing content to a user, receiving biosignal data of a user while the content is being provided, recognizing an emotion of the user with respect to the content by using an emotion classification model trained to classify emotions on the basis of a plurality of biosignal data labeled with emotions.

### BACKGROUND OF THE DISCLOSURE

### Technical Field

The present invention relates to an emotion recognition method and an emotion recognition device using the same, and more particularly, to an emotion recognition method which matches biosignal data and an emotion of a user to provide and an emotion recognition device using the same.

### Background Art

Emotions refer to mental states that humans may have and may be broadly divided into joy, anger, sorrow, and pleasure.

At this time, with regard to the emotions of the human, various technological developments are underway to evoke emotions by intended external stimuli or seek a psychological stability based thereon.

To be more specific, demands for building natural interactions between computer systems and humans are being increased in various smart environments such as head mount display (HMD) devices, human computer interaction (HCI), games, and motion-based control. To this end, demands for automatically analyzing and understanding human emotions are also being increased.

At this time, for the interaction between the humans and the computer systems, the intelligent system also needs to understand the feeling of the human and appropriately respond, like the communication between humans. Specifically, for the systems, functions of predicting and understanding the emotions of the humans, intentions of the humans, and mental states in various ways are essential.

In the meantime, the emotion recognition protocol of the related art induces or recognizes the emotions regardless of the tendency of each user to feel the emotions and always recognizes the emotion at the same initial level value, so that the reliability of the emotion recognition result may be low.

Specifically, in the emotion recognition protocol, it is difficult to customize analysis for various tendencies for every user and the emotion recognition result may have a big error.

Therefore, for intelligent emotion computing which naturally responds to the emotion of the human in the computer system, development for a new system which recognizes and analyzes emotional states of the human to improve an accuracy of recognizing emotions is consistently required.

### SUMMARY OF THE DISCLOSURE

The inventors of the invention have paid attention that with respect to emotions of the humans, changes in biosignals will precede as a part of the human body's response.

To be more specific, the inventors of the present invention have paid attention that biosignal data indicating various signals generated from the body of the user according to conscious and/or unconscious (for example, respiration, heartbeat, or metabolism) behaviors of the user, such as brain wave data, a pulse, or a blood pressure, may be related to human emotions.

Moreover, the inventors of the present invention have further paid attention to a HMD device which is capable of providing the biosignal data and providing various contents.

At this time, the HMD device may be a display device which is formed to be wearable on a head of the user to provide images related to virtual reality (VR), augmented reality (AR) and/or mixed reality (MR) to a user so that the user may have spatial and temporal experiences similar to the reality. Such a HMD device may be configured by a main body formed in the form of goggles to be worn on the user's eye area and a wearing unit which is connected to the main body to have a band shape to fix the main body to the head of the user. Moreover, the HMD device may include a sensor which acquires biosignal data of the user and further include a content output unit which outputs an emotion inducing content related to virtual reality, augmented reality, and/or mixed reality and an input unit which inputs a selection from the user.

Accordingly, the inventors of the present invention may recognize that the emotions of the user may be predicted and classified on the basis of the biosignal data of the user according to the contents provided from the HMD device.

At this time, in order to solve the problems of the protocol of the related art which induces or recognizes the emotions regardless of the tendency of the user to feel the emotions to recognize the emotion, the inventors of the present invention have intended to set a reference emotion which becomes a criteria for emotion recognition by matching the biosignal and user's individual emotion selections.

Moreover, the inventors of the present invention have intended to further apply a prediction model configured to classify the emotions of the user on the basis of the determined reference emotion, that is, biosignal data labeled with emotions, to the emotion recognition system.

Therefore, the inventors of the present invention expected to more sensitively and accurately infer the emotions of the user on the basis of the biosignals according to a newly generated event, by means of a prediction model configured to set a reference emotion for individual users and recognize emotions on the basis of the reference emotion.

At this time, the inventors of the present invention recognized that in the learning of the prediction model, learning data for classifying emotions and providing a recognition result with a high reliability was not sufficient.

In order to solve the above-mentioned problem, the inventors of the present invention intended to further apply vague emotion labeling data generated according to gaze and hesitation of the user during the process of making a selection on the emotion inducing content as learning data.

Specifically, the inventors of the present invention configured the prediction model to update vague emotion labeling data to which emotion selection of the user and biosignal data matched with a relatively low reliability or biosignal data which did not match any emotion to clear emotion labeling data in which the emotion selection of the user and biosignal data matched with a high reliability.

To be more specific, the inventors of the present invention configured the prediction model to separate a feature part of the vague emotion labeling data which is relatively difficult to classify labels according to emotions as specific emotions and update a feature part of the clear labeling data based on this.

Therefore, an object to be achieved by the present invention is to provide an emotion recognition method on the basis of an emotion classification model configured to recognize emotions of the user on the basis of biosignal data acquired while content is being provided.

To be more specific, an object to be achieved by the present invention is to provide an emotion recognition method using an emotion classification model configured to update learning model on the basis of first labeled biosignal data and/or second labeled biosignal data by the selection of the user and classify emotions for new biosignal data on the basis of the learning model.

Another object to be achieved by the present invention is to provide an emotion recognition device including a receiver configured to receive biosignal data of a user while content is being provided and a processor configured to recognize an emotion of the user using an emotion classification model trained to classify emotions.

Objects of the present disclosure are not limited to the above-mentioned objects, and other objects, which are not mentioned above, may be clearly understood by those skilled in the art from the following descriptions.

In order to achieve the above-described object, provided are an emotion recognition method and an emotion recognition device according to an exemplary embodiment of the present invention. According to an exemplary embodiment of the present invention, an emotion recognition method using biosignal data of a user which is performed by a processor is an emotion recognition method implemented by a processor, including: providing content to a user; receiving biosignal data of a user while the content is being provided, recognizing an emotion of the user with respect to the content by using an emotion classification model trained to classify emotions on the basis of a plurality of biosignal data labeled with emotions. At this time, the plurality of labeled biosignal data includes first labeled biosignal data matching the emotion of the user and second labeled biosignal data which has a lower labeling reliability than that of the first labeled biosignal data or does not match any emotion of the user.

According to a characteristic of the present invention, the emotion classification model may be a model trained by: receiving at least one of labeled biosignal data between the first labeled biosignal data and the second labeled biosignal data; encoding at least one of received labeled biosignal data; decoding at least one of encoded labeled biosignal data so as to acquire reconfigured biosignal data; and training a feature part determined by the emotion classification model to minimize a difference between the at least one of received labeled biosignal data and the reconfigured biosignal data.

According to another characteristic of the present invention, the feature part may include a first feature part including a feature variable with respect to the first labeled biosignal data and a second feature part including a feature variable with respect to the second labeled biosignal data. Further, training a feature part may include: comparing feature variables of the first feature part and the second feature part; and updating the feature variable of the second feature part to the first feature part on the basis of a comparison result.

According to still another characteristic of the present invention, there is a plurality of user's emotions and the first feature part may include a feature variable with respect to each of the plurality of user's emotions. Moreover, the second feature part may include at least one feature variable, among a feature variable for each of the plurality of emotions, a feature variable with respect to two or more combined emotions selected from the plurality of emotions, and a feature variable with respect to an emotion different from the plurality of emotions.

According to still another characteristic of the present invention, the method further may include repeating: receiving at least one of labeled biosignal data; encoding at least one of biosignal data; decoding the at least one of encoded biosignal data, and training a feature part.

According to still another characteristic of the present invention, encoding at least one of labeled biosignal data may include: encoding to extract a feature variable with respect to the at least one of labeled biosignal data. Further, after encoding at least one of labeled bio signal data, determining a feature part on the basis of the extracted feature variable may be further performed.

According to still another characteristic of the present invention, f recognizing an emotion of the user with respect to the content may include: classifying an emotion of the user with respect to the content, on the basis of the biosignal data of the user, by means of the feature part.

According to still another characteristic of the present invention, the emotion classification model further includes a classification unit connected to the feature part, and recognizing an emotion of the user with respect to the content may include: first-classifying an emotion of the user with respect to the content, on the basis of the biosignal data of the user, by means of the feature part and second-classifying the emotion of the user with respect to the content, by means of an emotion classification unit.

According to still another characteristic of the present invention, the method may further include labeling a biosignal acquired from the user on the basis of the emotion of the user so as to acquire labeled biosignal data, before providing content to a user.

According to still another characteristic of the present invention, labeling on the basis of the emotion of the user may include: providing emotion inducing content to the user; receiving biosignal data of the user while the emotion inducing content is being selected; receiving selection on the emotion inducing content; and matching the selection and the biosignal data so as to acquire the labeled biosignal data.

According to still another characteristic of the present invention, the method may further include receiving gaze data with respect to the emotion inducing content, and the selection may include staring on at least one of content selected from the emotion inducing contents.

According to still another characteristic of the present invention, when the staring is maintained for a predetermined time or longer, matching the biosignal data may include: matching the selection and the biosignal data as first labeled biosignal data. Further, when the staring is maintained shorter than a predetermined time, matching the biosignal data may include: matching the selection and the biosignal data as second labeled biosignal data.

According to still another characteristic of the present invention, the biosignal data may be at least one of brain wave data and gaze data of the user.

According to an exemplary embodiment of the present invention, an emotion recognition device includes: an output unit configured to provide content to a user; a receiver configured to receive biosignal data of a user while the content is being provided; a processor connected to communicate with the receiver and the output unit. At this time, the processor is configured to recognize an emotion of the user with respect to the content by using an emotion classification model trained to classify emotions on the basis of a plurality of biosignal data labeled with emotions. Moreover, the plurality of labeled biosignal data includes first labeled biosignal data matching the emotion of the user and second labeled biosignal data of the biosignal data which has a lower labeling reliability than that of the first labeled biosignal data or does not match the emotion of the user.

According to a characteristic of the present invention, the emotion classification model may be a model trained by: receiving at least one of labeled biosignal data between the first labeled biosignal data and the second labeled biosignal data; encoding at least one of received labeled biosignal data; decoding at least one of encoded labeled biosignal data by means of a feature part determined by the emotion classification model so as to acquire reconfigured biosignal data; and training a feature part to minimize a difference between the at least one of received labeled biosignal data and the reconfigured biosignal data.

According to another characteristic of the present invention, the feature part includes a first feature part including a feature variable with respect to the first labeled biosignal data and a second feature part including a feature variable with respect to the second labeled biosignal data. Moreover, the feature part may be configured to compare the feature variables of the first feature part and the second feature part and update the feature variable of the second feature part to the first feature part on the basis of a comparison result.

According to still another characteristic of the present invention, there is a plurality of user's emotions, the first feature part includes a feature variable with respect to each of the plurality of user's emotions, and the second feature part includes at least one feature variable, among a feature variable for each of the plurality of emotions, a feature variable with respect to two or more combined emotions selected from the plurality of emotions, and a feature variable with respect to an emotion different from the plurality of emotions.

According to another characteristic of the present invention, the emotion classification model may be a model trained by repeating: receiving at least one of labeled biosignal data; encoding at least one of biosignal data; decoding at least one of encoded biosignal data; and training the feature part.

According to still another characteristic of the present invention, the emotion classification model is further configured to encode the at least one of labeled biosignal data so as to extract a feature variable with respect to the at least one of labeled biosignal data and the feature part may be determined on the basis of the extracted feature variable.

According to still another characteristic of the present invention, the feature part may be further configured to classify an emotion of the user with respect to the content on the basis of the biosignal data of the user.

According to still another characteristic of the present invention, the emotion classification model may further include a classification unit which is connected to the feature part and is configured to classify an emotion of the user with respect to the content on the basis of an output value of the feature part.

Other detailed matters of the exemplary embodiments are included in the detailed description and the drawings.

According to the present invention, a reference emotion which becomes a reference for recognizing an emotion for individual users is determined and provided to solve the problems of the protocols of the related art which induce or recognize the emotions regardless of a tendency of every user to feel the emotions to recognize the emotions.

To be more specific, the emotion selection for the user is input by providing an emotion inducing content which evokes an emotion and is matched with biosignal data of the user acquired from the selection to determine a reference emotion for individual users.

Moreover, according to the present invention, a prediction model configured to classify emotions of the user on the basis of the reference emotion is further applied to the emotion recognition system and an emotion recognition system which more sensitively and precisely induces the emotion of the user on the basis of the biosignal according to a newly generated event may be provided.

Further, according to the present invention, vague recognition data generated according to gaze and hesitation of the user during the process of making a selection on the emotion inducing content is provided as learning data to contribute to improvement of an emotion classifying performance of the prediction model configured to classify and recognize emotions.

The effects according to the present disclosure are not limited to the contents exemplified above, and more various effects are included in the present disclosure.

### BRIEF DESCRIPTION OF THE DRAWINGS

FIG. 1 is a schematic view for explaining an emotion recognition system using biosignal data according to an exemplary embodiment of the present invention.

FIG. 2 is a schematic view for explaining an emotion recognition device according to an exemplary embodiment of the present invention.

FIGS. 3A to 3E illustrate an emotion labeling step for acquiring first labeled biosignal data and second labeled biosignal data for training an emotion classification model used for various exemplary embodiments of the present invention.

FIG. 3F is a schematic flowchart for explaining a method for training an emotion classification model used for various exemplary embodiments of the present invention.

FIG. 3G illustrates a configuration of an emotion classification model used for an emotion recognition method according to an exemplary embodiment of the present invention.

FIG. 4A is a schematic flowchart for explaining an emotion recognition method based on an emotion classification model, in an emotion recognition method according to an exemplary embodiment of the present invention.

FIGS. 4B and 4C illustrate an emotion classifying step on the basis of an emotion classification model, in an emotion recognition method according to an exemplary embodiment of the present invention.

### DETAILED DESCRIPTION OF THE EMBODIMENT

Advantages and characteristics of the present disclosure and a method of achieving the advantages and characteristics will be clear by referring to exemplary embodiments described below in detail together with the accompanying drawings. However, the present invention is not limited to the following exemplary embodiments but may be implemented in various different forms. The exemplary embodiments are provided only to complete the disclosure of the present disclosure and to fully provide a person having ordinary skill in the art to which the present invention pertains with the category of the disclosure, and the present disclosure will be defined by the appended claims.

Although the terms “first”, “second”, and the like are used for describing various components, these components are not confined by these terms. These terms are merely used for distinguishing one component from the other components. Therefore, a first component to be mentioned below may be a second component in a technical concept of the present disclosure.

Like reference numerals generally denote like elements throughout the specification.

The features of various embodiments of the present disclosure may be partially or entirely bonded to or combined with each other and may be interlocked and operated in technically various ways understood by those skilled in the art, and the embodiments may be carried out independently of or in association with each other.

In the present invention, the emotion recognition system may include all devices configured to acquire gaze of a user and acquire biosignal data such as a brain wave of the user, without being limited. For example, the emotion recognition system may include a device which is in contact with/is worn on a part of the user's body and includes a sensor for acquiring biosignal data of a user, such as a head set, a smart ring, a smart watch, an ear-set, and an earphone, as well as an HMD device, a content output device which outputs an emotion inducing content related to virtual reality, augmented reality, or/and mixed reality, and an electronic device which manages the above-devices. For example, when the HMD device includes an output unit, the emotion recognition system may include only the HMD device and the electronic device.

Here, biosignal data may indicate various signals generated from the body of the user according to conscious and/or unconscious (for example, respiration, heartbeat, or metabolism) behaviors of the user, such as brain wave data, gaze data, a pulse, a blood pressure, and a brain wave of the user. To be more specific, the biosignal data may include all data of the user which is capable of being provided as time-series data. Desirably, the biosignal data in the present specification may be brain wave data and/or gaze data of the user according to the providing of contents. For example, time series brain wave data acquired while content is being provided and gaze data in which information such as blinking, a pupil size, a pupil shape, a pupil position, and a viewing position is reconfigured as time-series data may be applied to the user emotion recognition system.

Hereinafter, various exemplary embodiments of the present disclosure will be described in detail with reference to accompanying drawings.

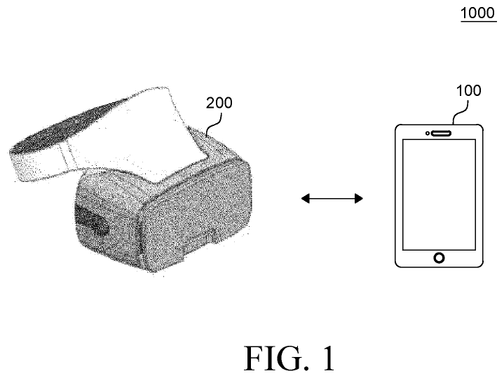

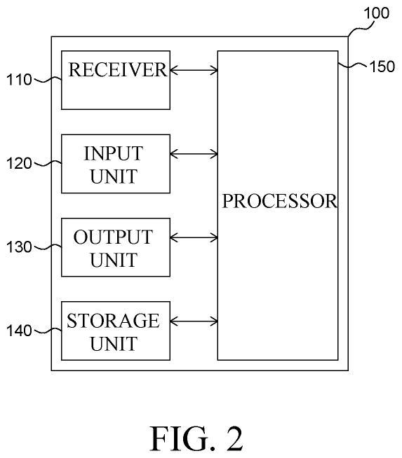

FIG. 1 is a schematic view for explaining an emotion recognition system using biosignal data according to an exemplary embodiment of the present invention. FIG. 2 is a schematic view for explaining an emotion recognition device according to an exemplary embodiment of the present invention.

First, referring to FIG. 1, the emotion recognition system 1000 may be a system which recognizes emotions with respect to biosignal data including at least one of a brain wave and gaze data of the user according to the providing of the contents. At this time, the emotion recognition system 1000 may be configured by an emotion recognition device 100 which recognizes emotions of the user on the basis of the biosignal data and an HMD device 200 for acquiring biosignal data of the user.

At this time, the emotion recognition device 100 is configured to be communicably connected to the HMD device 200 and provide contents which evoke emotions to the HMD device 200. Moreover, the emotion recognition device 100 is a device which recognizes emotions on the basis of the biosignal data acquired by the HMD device 200 and selection on the emotion inducing contents and may include a personal computer (PC), a notebook, a workstation, a smart TV, and the like.

To be more specific, referring to FIG. 2, the emotion recognition device 100 may include a receiver 110, an input unit 120, an output unit 130, a storage unit 140, and a processor 150.

At this time, the receiver 110 may be configured to receive biosignal data of the user according to the providing of contents. According to various exemplary embodiments, the receiver 110 may be further configured to receive gaze data with respect to the contents.

According to a characteristic of the present invention, the receiver 110 may be configured to receive brain wave data and gaze data of the user according to the providing of the contents. For example, the receiver 110 may be configured to receive time series brain wave data acquired while the content is being provided and gaze data in which information such as blinking, a pupil size, a pupil shape, a pupil position, and a viewing position is reconfigured as time-series data.

The input unit 120 may receive the selection of the user according to the providing of the contents. In the meantime, the user may set the emotion recognition device 100 by means of the input unit 120.

According to an exemplary embodiment of the present invention, the input unit 120 may be an input unit of an HMD configured to be connected to the HMD device 200 to receive the selection of the user.

The output unit 130 may be configured to provide an interface screen for the content. Here, the interface screen may include a display space and an input space which represent contents or include a graphic space.

However, the contents are not limited to those described above, but may be provided through the output unit of the HMD device 200 to be described below.

Moreover, the output unit 130 may be configured to output information about an emotion of the user according to the providing of the contents, which is determined by the processor 150 to be described below.

The storage unit 140 may be configured to store various biosignal data received by the receiver 110, settings of the user input by means of the input unit 120, and contents provided by means of the output unit 130. Moreover, the storage unit 140 may be further configured to store biosignal data recognized by the processor 150 to be described below and classified emotions of the user. However, the storage unit is not limited thereto so that the storage unit 140 may be configured to store all data generated during a process of classifying emotions with respect to biosignal data by the processor 150.

The processor 150 may be configured to recognize emotions on the basis of the biosignal data acquired by means of the HMD device 200. To be more specific, when the contents are provided by means of the interface screen of the output unit 130, the biosignal data acquired from the HMD device 200 is received by the receiver 110 and the processor 150 may be configured to recognize the emotion of the user on the basis of the biosignal data.

In the meantime, the emotion recognition by the processor 150 may be performed by an emotion classification model trained to learn biosignal data to which an emotion is labeled in advance to extract an emotion on the basis of new biosignal data. For example, the processor 150 may be configured to learn biosignal data labeled with an emotion based on a deep learning algorithm and classify and recognize an emotion of the user from various bio feature data such as brain wave feature data and gaze feature data on the basis of the biosignal data.

According to another characteristic of the present invention, the processor 150 may further use a classification model configured to update vague emotion labeling data to which emotion selection of the user and bio signal data match with a relatively low reliability or biosignal data which does not match any emotion to clear emotion labeling data to which the emotion selection of the user and biosignal data match with a high reliability to recognize the emotion.

At this time, the deep learning algorithm may be at least one of a deep neural network (DNN), a convolutional neural network (CNN), a deep convolution neural network (DCNN), a recurrent neural network (RNN), a restricted Boltzmann machine (RBM), a deep belief network (DBN), and a single shot detector (SSD). However, it is not limited thereto and the processor 150 may operate based on more various algorithms as long as the algorithms learn the reference emotion to classify the emotion on the basis of new biosignal data.

Referring to FIG. 1 again, the HMD device 200 may be a complex virtual experience device which provides contents for virtual reality to the user to allow the user to have spatial and temporal experiences similar to the reality and acquires biosignal data of the user to sense physical, cognitive, and emotional changes of the user who is undergoing a virtual experience. For example, contents may include non-interactive images such as movies, animations, advertisements, or promotional images and interactive images which interact with the user, such as games, electronic manuals, electronic encyclopedias, or promotional images, but are not limited thereto. Here, the image may be a three-dimensional image and include stereoscopic images. Moreover, the emotion inducing content may include a voice query for the user's emotion.

The HMD device 200 may be formed with a structure which is wearable on a head of the user and may be implemented to process various contents for virtual reality through an output unit in the HMD device 200.

When the HMD device 200 includes an output unit, if the user wears the HMD device 200, the HMD device may be disposed such that one surface of the output unit faces a face of the user to allow the user to check the contents.

At least one sensor (not illustrated) which acquires a brain wave or gaze data of the user may be formed at one side of the HMD device 200. At least one sensor may include a brain wave sensor which measures a brain wave of the user and/or a gaze tracking sensor which tracks staring or gaze of the user. According to various exemplary embodiments, at least one sensor is formed in a position which is capable of photographing eyes or a face of the user or is being in contact with a skin of the user. When the user wears the HMD device 200, the sensor photographs the eyes or the face of the user and analyzes the photographed image to acquire gaze data or comes into contact with the skin of the user to acquire biosignal data such as electroencephalography (EEG), electromyography (EMG), or electrocardiogram (ECG). In the present specification, although it is described that the HMD device 200 includes at least one sensor which acquires a brain wave or gaze data of the user, it is not limited thereto so that at least one sensor which acquires a brain wave or gaze data of the user is mounted in an HMD housing by means of a module separated from the HMD device 200. The expression of the HMD device 200 is intended to include such a module or introduce the module itself.

The HMD device 200 acquires biosignal data of the user according to a request of the emotion recognition device 100 and transmits the acquired biosignal data to the emotion recognition device 100 by means of the output unit or the receiver.

When the HMD device 200 includes an output unit, the HMD device may display the contents through the output unit of the HMD device 200. Moreover, the biosignal data while content is being provided through at least one sensor equipped in the HMD device 200 may be acquired. At this time, the HMD device 200 may transmit the acquired biosignal data to the emotion recognition device 100.

The emotions for individual users according to the providing of contents may be recognized by such an emotion recognition system 1000 with a higher precision. Specifically, the emotion recognition system 1000 of the present inventions provides a classification model which uses vague motion labeled biosignal data generated according to gaze and hesitation of the user during the process of making a selection on the emotion inducing content as additional learning data to provide emotion classification and recognition results with a high reliability.

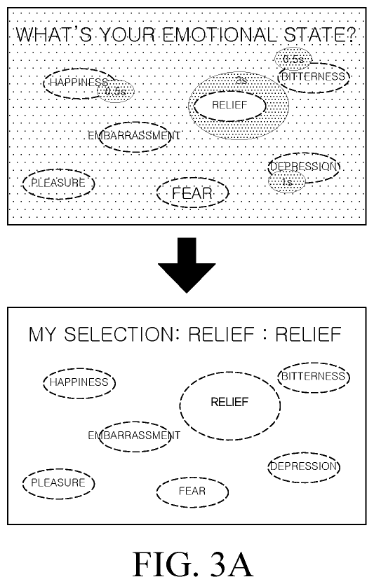

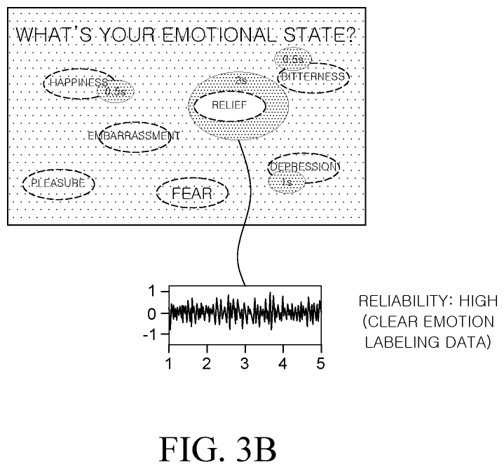

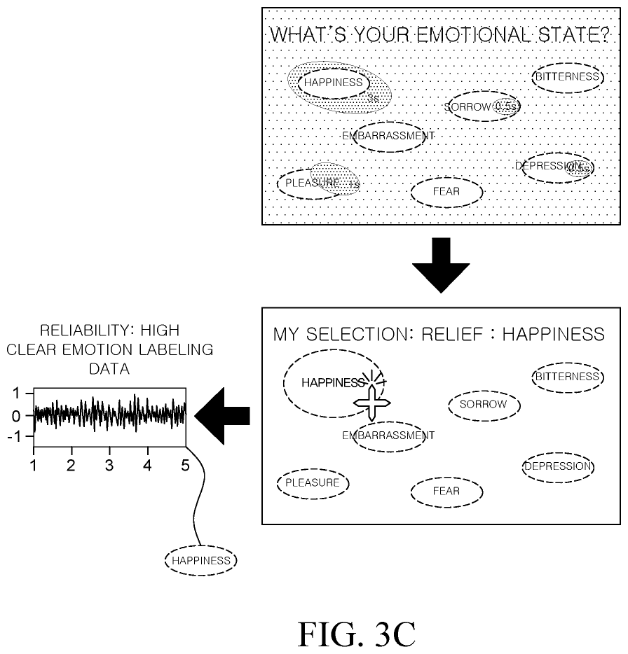

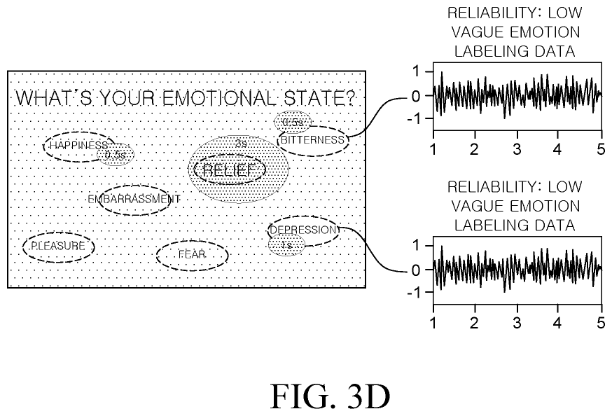

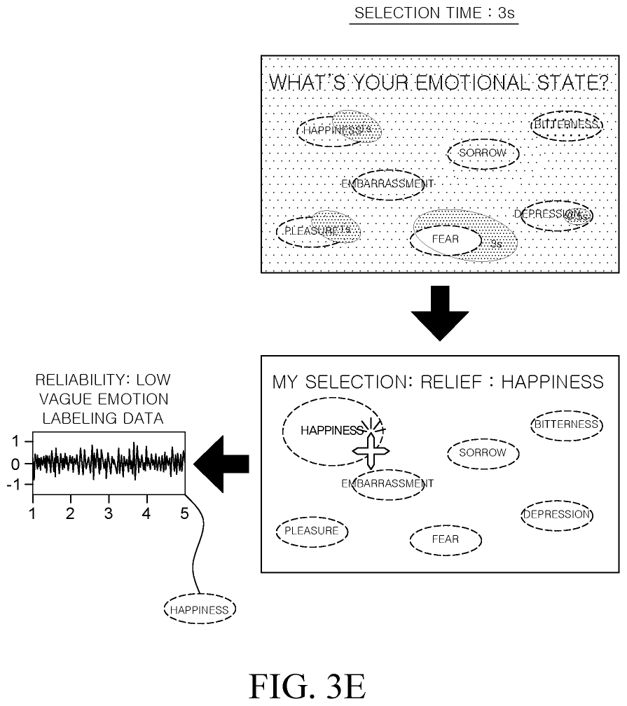

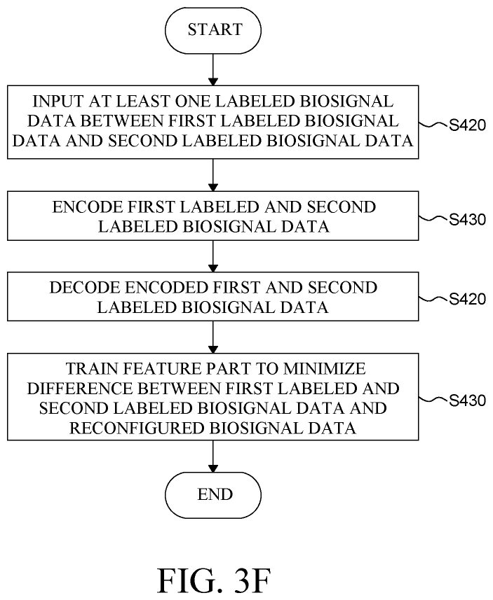

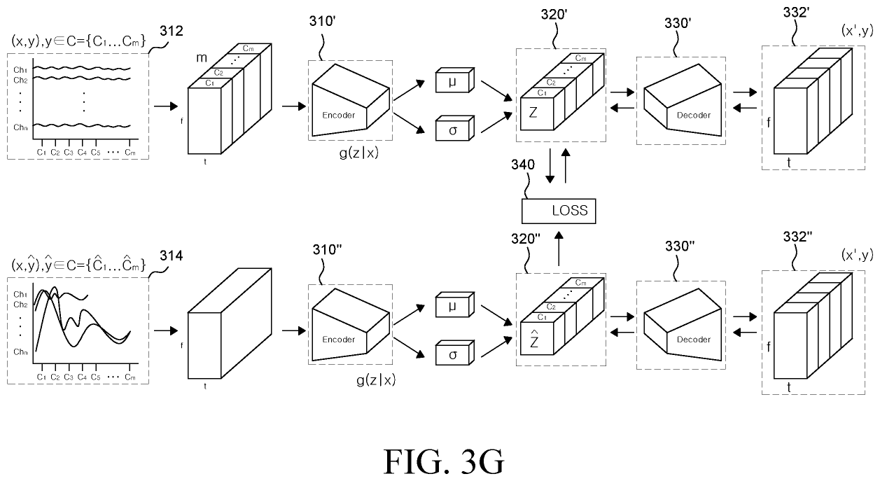

Hereinafter, a method of training an emotion classification model used for various exemplary embodiments of the present invention will be described in detail with reference to FIGS. 3A to 3G.

First, for the learning of the emotion classification model, first labeled biosignal data and second labeled biosignal data which has a lower labeling reliability than that of the first labeled biosignal data or does match any emotion may be used.

At this time, as biosignal data which matches the emotion of the user to be labeled, brain wave data is explained as an example, but is not limited thereto.

For example, gaze data in which information such as blinking, a pupil size, a pupil shape, a pupil position, and a viewing position is reconfigured as time-series data may match the selected emotion of the user to be labeled, together with time series brain wave data acquired while the emotion inducing content is being provided.

In the meantime, the first labeled biosignal data and the second labeled biosignal data may be acquired by a labeling step.

For example, referring to FIG. 3A, the user is provided with a plurality of emotion inducing contents configured by a plurality of emotional words such as “happiness”, “embarrassment”, “pleasure”, “fear”, “sorrow”, “bitterness”, and “depression”, together with the emotion inducing query, through the HMD device. Thereafter, the staring of the user may be performed according to the providing of the plurality of emotion inducing contents. At this time, according to a user's staring level on each of the plurality of emotional words, the selection of the user may be made. To be more specific, the emotional word “relief” is stared for three seconds, which indicates a longer staring level than that of the emotional words of “happiness”, “bitterness”, and “depression” so that “relief” may be selected as the emotion of the user. According to another exemplary embodiment of the present invention, the “relief” which is stared longer than a predetermined staring time (for example, two seconds) may be selected as an emotion of the user. In the meantime, the “relief” which is an emotional word selected by the user may be output to be bigger than the other emotional words. Next, further referring to FIG. 3B, a biosignal acquired while the user is staring at the “relief”, for example, brain wave data may be recognized by being matched with the “relief” which is selected by the user. In the meantime, the bio signal data matching the “relief”, that is, the emotion labeling data may have a relatively higher reliability than those of emotion labeling data matching the emotional words such as “happiness”, “bitterness”, and “depression” having a relatively low staring level and biosignal data according to staring. That is, it may be determined as first labeled biosignal data having a relatively higher reliability of matching biosignal data matching the “relief”.

As another example, referring to FIG. 3C, the user is provided with a plurality of emotion inducing contents configured by a plurality of emotional words, such as “happiness”, “embarrassment”, “pleasure”, “fear”, “sorrow”, “bitterness”, and “depression”, together with the emotion inducing query, through the HMD device. Next, the staring of the user may be performed according to providing of the emotion inducing query and a plurality of emotional words. At this time, a staring level of the user for each of the plurality of emotional words may be measured. Thereafter, “happiness” which is selected by the user according to the providing of the emotion inducing query and the plurality of emotional words may be input through the input unit of the HMD device. That is, a biosignal acquired while “happiness” is being input through the HMD device, for example, biosignal data that the brain wave data matches the “happiness” selected by the user to recognize the emotion may be acquired. At this time, the “happiness” which is selected by the user may be an emotional word having the longest staring time, among the plurality of emotional words. Therefore, the biosignal data matching the “happiness”, that is, the emotion labeling data may be determined as the first labeled biosignal data having a reliability higher than biosignal data having a relatively short staring time recognized for an emotional word selected by the HMD device.

Further, as still another example, referring to FIG. 3D, the user is provided with a plurality of emotion inducing contents configured by the emotion inducing query and a plurality of emotional words such as “happiness”, “embarrassment”, “pleasure”, “fear”, “sorrow”, “bitterness”, and “depression”, through the HMD device. Next, the staring of the user may be performed according to providing of the emotion inducing query and a plurality of emotional words. At this time, the biosignal data acquired while staring at the emotional words such as “happiness”, “bitterness”, and “depression”, except for the “relief” having the longest staring time or a staring time equal to or longer than a predetermined time (for example, two seconds) may match each emotional word and vague emotion labeling data. That is, the biosignal data matching “happiness”, “bitterness”, and “depression”, that is, the emotion labeling data may be determined as second labeled biosignal data having a lower reliability than the “relief” and the recognized biosignal data.

Further, as another example, referring to FIG. 3E, the user is provided with a plurality of emotion inducing contents configured by the emotion inducing query and a plurality of emotional words, such as “happiness”, “embarrassment”, “pleasure”, “fear”, “sorrow”, “bitterness”, and “depression”, through the HMD device. Next, the user's selection may be made by means of the input unit of the HMD device together with the staring of the user according to the providing of the emotion inducing query and the plurality of emotional words. At this time, the “happiness” selected by the user is different from the “fear” having the longest staring time or a staring time equal to or longer than a predetermined time (for example, two seconds). That is, the “happiness” selected by the user and biosignal data acquired while making the selection may match as vague emotional labeling data. That is, the biosignal data matching “happiness”, “bitterness”, and “depression”, that is, the emotion labeling data may be determined as second labeled biosignal data having a lower reliability than the “relief” and the recognized biosignal data, that is, having vague labeling.

That is, the method of acquiring the first labeled biosignal data and the second labeled biosignal data is not limited to the above-description. For example, as long as the first labeled biosignal data has a Gaussian distribution diagram clearly distinguished for every matched emotion label and the second labeled biosignal data has a Gaussian distribution diagram which are not clearly distinguished for every emotion label, the first labeled biosignal data and the second labeled biosignal data may be acquired by various methods.

FIG. 3F is a schematic flowchart for explaining a method for training an emotion classification model used for various exemplary embodiments of the present invention.

First, according to an emotion recognition method according to an exemplary embodiment of the present invention, the emotion classification model receives first labeled biosignal data and second labeled biosignal data which is labeled vaguer than the first labeled biosignal data (S310). Next, the input first labeled and second labeled biosignal data are encoded (S320). Next, in order to acquire reconfigured biosignal data, by means of a feature part determined by an emotion classification model, the training is performed by decoding encoded first and second labeled biosignal data (S330) and training a feature part to minimize the difference between the input first labeled and second labeled biosignal data and the reconfigured biosignal data (S340).

To be more specific, in receiving the first labeled biosignal data and the second labeled biosignal data, the first labeled biosignal data and the second labeled biosignal data are input as learning data of the classification model.

At this time, in the step S310 of receiving the first labeled biosignal data and the second labeled biosignal data, the first labeled biosignal data and the second labeled biosignal data which are used as learning data may be brain wave data and/or gaze data which are labeled in advance. To be more specific, the first labeled brain wave data which clearly matches the emotion of the user and the second labeled brain wave data which does not clearly match the emotion of the user or does not match any of emotions may be used as learning data. Moreover, first labeled gaze data in which gaze data in which information blinking, a pupil size, a pupil shape, a pupil position, and a viewing position is reconfigured as time-series data clearly matches the user's selected emotion and second labeled gaze data which does not clearly match the emotion of the user or does not match any of emotions may be used as learning data.

For example, referring to FIG. 3G, according to the exemplary embodiment of the present invention, in the step S310 of receiving the first labeled biosignal data and the second labeled biosignal data, first labeled brain wave data 312 of the clear emotion labeling biosignal data and second labeled brain wave data 314 of vague emotion labeling biosignal data may be input through encoders 310′ and 310″.

At this time, x indicates input biosignal data, y indicates an emotion label which clearly matches x, Y\hat{ } may be an emotion label which vaguely matches x or is not present.

Next, referring to FIG. 3F again, in the step S320 of encoding first labeled and second labeled biosignal data, input first labeled biosignal data and second labeled biosignal data may be encoded.

According to another characteristic of the present invention, in the step S320 of encoding first labeled and second labeled biosignal data, the data may be encoded to extract feature variables for the first labeled and second labeled biosignal data.

According to another characteristic of the present invention, in the step S320 of encoding first labeled and second labeled biosignal data, each feature variable may be output as a parameter for a probability distribution, for example, μ, and σ of Gaussian normal distribution, but is not limited thereto.

According to still another characteristic of the present invention, after the step S320 of encoding first labeled and second labeled biosignal data, a feature part may be further determined on the basis of the extracted feature variable.

To be more specific, a first feature part is determined on the basis of a feature variable extracted from the first labeled biosignal data and a second feature part is determined on the basis of a feature variable extracted from the first labeled biosignal data.

At this time, there is a plurality of emotions of a user, the first feature part includes feature variables for the plurality of emotions of the user, the second feature part may include at least one of a feature variable for each of the plurality of emotions, a feature variable for two or more combined emotions selected from the plurality of emotions, and a feature variable for an emotion different from the plurality of emotions.

For example, referring to FIG. 3G, in the step S340 of training a feature part, a feature variable of the feature part \hat{z} 320″ may be updated to the feature part z 320′ to minimize the difference between x of the input biosignal data and x′ of the reconfigured biosignal data.

At this time, the feature part z 320′ may be updated by an updating unit 340. To be more specific, in the step S340 of training a feature part, characteristics of the feature part \hat{z} 320″ configured by a feature variable extracted from the second labeled brain wave data 314 may be classified by the following Equation 1.

$$f ( {X}_{{\hat{c}}_{1 i}} , {X}_{{\hat{c}}_{1 j}} ) = \frac{αγ ( {N}_{{\hat{c}}_{1 i}} ) γ ( {N}_{{\hat{c}}_{1 j}} ) P ( {X}_{{\hat{c}}_{1 i}} \vert {∅}_{{\hat{c}}_{1 i}} ) P ( {X}_{{\hat{c}}_{1 j}} \vert {∅}_{{\hat{c}}_{1 j}} )}{γ ( {N}_{{\hat{c}}_{1}} ) P ( {X}_{{\hat{c}}_{1}} \vert {∅}_{{\hat{c}}_{1}} )} \begin{matrix}if f ( 0 ) < 1 , then ( {\hat{c}}_{1 i} , {\hat{c}}_{1 j} ) = {\hat{c}}_{1} \\ \begin{matrix}if f ( 0 ) > 1 , then & {\hat{c}}_{1 i} = {\hat{c}}_{1} \\ & {\hat{c}}_{1 j} = {\hat{c}}_{m + 1}\end{matrix}\end{matrix} \qquad [ Equation 1 ]$$

Here, γ is a gamma function and N is a number of samples of the corresponding data.

For example, the feature part \hat{z} 320″ is configured by feature variables of the second labeled biosignal data which is vague data so that the feature variable may include two or more emotion labels or include a totally different emotion. Therefore, it is necessary to classify the characteristic to find whether the feature part \hat{z} 320″ is simply included in the feature part z 320′ or separately included during the updating process. Therefore, a property of the feature part \hat{z} 320″ may be classified on the basis of a value of f(0) by means of Equation 1, after dividing the feature variables of the feature part \hat{z} 320″ into two groups cli and clj by the clustering. If a value of f(0) is smaller than 1, two groups may have one property and if the value of f(0) is larger than 1, two groups may have two different properties. Accordingly, the feature part \hat{z} 320″ may be updated as a minimum feature value which may be distinguished by characteristic classification based on Equation 1.

Next, the updated feature part \hat{z} 320″ may be finally updated to the feature part z 320′ by the following Equation 2.

$$f ( {X}_{{c}_{1}} , {X}_{{\hat{c}}_{1}} ) = \frac{αγ ( {N}_{{\hat{c}}_{1 i}} ) γ ( {N}_{{\hat{c}}_{1 j}} ) P ( {X}_{{\hat{c}}_{1 i}} \vert {∅}_{{\hat{c}}_{1 i}} ) P ( {X}_{{\hat{c}}_{1 j}} \vert {∅}_{{\hat{c}}_{1 j}} )}{γ ( {N}_{{\hat{c}}_{1}} ) P ( {X}_{{\hat{c}}_{1}} \vert {∅}_{{\hat{c}}_{1}} )} \begin{matrix}if f ( 0 ) < 1 , then ( {X}_{{c}_{1}} , {X}_{{\hat{c}}_{1}} ) = {X}_{{c}_{1}} \\ \begin{matrix}if f ( 0 ) > 1 , then & {X}_{{c}_{1}} = {X}_{{c}_{1}} \\ & {X}_{{\hat{c}}_{1}} = {X}_{{c}_{m + 1}}\end{matrix}\end{matrix} \qquad [ Equation 2 ]$$

For example, the feature part \hat{z} 320″ including the updated feature variable is compared with the feature variable of the feature part z 320′ by Equation 2 and finally, the feature part z 320′ may be updated to include an updated feature variable of the feature part \hat{z} 320″.

According to the above-mentioned method, the emotion classification model used for various exemplary embodiments of the present invention may be configured to further use not only first labeled biosignal data of clear emotion labeling data in which the user's emotion selection and the biosignal data match with a higher reliability, but also the second labeled biosignal data of vague emotion labeling data in which the user's emotion selection and the bio signal data match with a relatively lower reliability for the learning. As a result, the emotion classification model may be trained to provide the emotion classification and recognition results with a high reliability.

In the meantime, when the labeled gaze data is used to train the emotion classification model, the gaze data is received as image data so that the learning module of the emotion classification model may be configured to extract two features for the same emotion level separately from the brain wave data.

More, the learning module with the above-described structure may be configured to further apply a neural network configured to infer an image feature, such as a CNN to extract a feature of the gaze data.

Further, the configuration for training the emotion classification model of the present invention is not limited thereto. For example, encoding parts to which the first labeled and second labeled biosignal data are input to extract a feature and a decoding part which reconfigures them may be configured by a plurality of layers of (Convolution+Relu+Pooling)+[Feature Map]+(Convolution+Relu+Pooling).

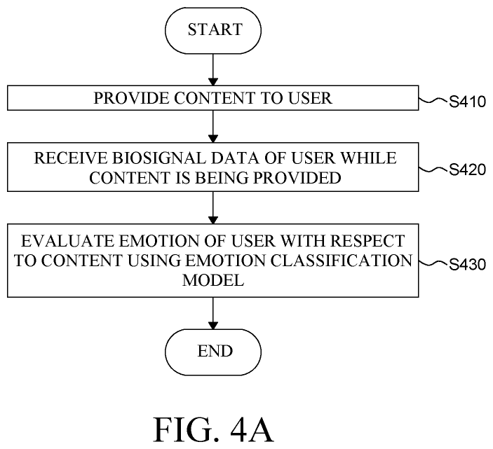

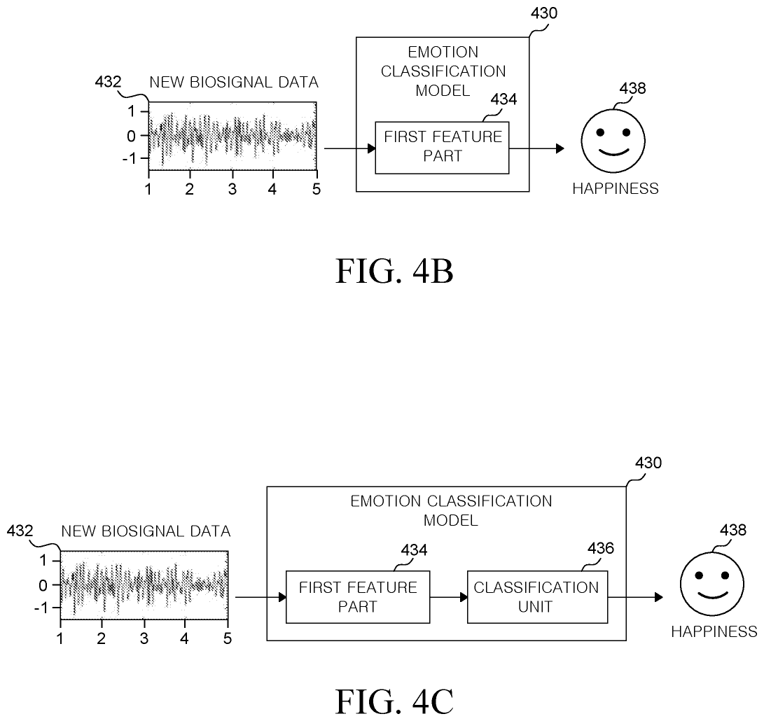

Hereinafter, an emotion recognition of an emotion recognition method based on an emotion classification model according to an exemplary embodiment of the present invention will be described in detail with reference to FIGS. 4A to 4C.

FIG. 4A is a schematic flowchart for explaining an emotion recognition method based on an emotion classification model, in an emotion recognition method according to an exemplary embodiment of the present invention. FIGS. 4B and 4C illustrate an emotion classifying step based on an emotion classification model, in an emotion recognition method according to an exemplary embodiment of the present invention.

First, referring to FIG. 4A, according to an emotion recognition method according to an embodiment of the present invention, a content which evokes an emotion is provided to a user (S410). Next, biosignal data of the user while the content is being providing is received (S420) and an emotion of the user with respect to the content is recognized on the basis of an emotion classification model (S430).

According to a characteristic of the present invention, in providing a content to the user (S410), at least one content of voices, images, movies, animations, advertisements, promotional images, and texts which express an emotion may be provided. To be more specific, in the step S410 of providing a content to the user, non-interactive images such as movies, animations, advertisements, or promotional images and interactive images which interact with the user, such as games, electronic manuals, electronic encyclopedias, or promotional images may be provided as a content.

Next, in the step S420 of receiving biosignal data of the user, biosignal data according to providing of the content may be received.

According to a characteristic of the present invention, in the step S420 of receiving biosignal data of the user, brain wave data and/or gaze data of the user may be received. However, it is not limited thereto, so that various signals generated from the body of the user according to conscious and/or unconscious (for example, respiration, heartbeat, or metabolism) behaviors of the user such as a pulse or a blood pressure may be received.

According to another characteristic of the present invention, in the step S420 of receiving biosignal data of the user, new biosignal data may be received from the HMD device.

Finally, in the step S430 of recognizing an emotion of the user with respect to the content, the emotion of the user may be classified and recognized by the emotion classification model trained by the above-described method.

According to a characteristic of the present invention, in the step S430 of recognizing an emotion of the user, the emotion of the user with respect to the content may be recognized on the basis of the biosignal data of the user, by means of a feature part of the emotion classification model.

For example, referring to FIG. 4B, in the step S430 of recognizing an emotion of the user with respect to the content, new biosignal data 432 is input to the feature part 434 of the emotion classification model 430. At this time, the feature part 434 may be a potential space or a feature map including a feature variable updated to a feature variable extracted from the second labeled biosignal data, together with a feature variable extracted from the first labeled biosignal data. That is, the new biosignal data 432 is input to the feature part 434 and then output as a predetermined emotion, and a class of the emotion may be classified and output on the basis of the emotion output value. For example, the new biosignal data 432 may be finally classified and output as happiness 438 and the emotion of the user with respect to the content may be recognized as happiness.

According to another characteristic of the present invention, in the step S430 of recognizing the emotion of the user with respect to the content, the emotion of the user with respect to the content may be first-classified by means of the feature part of the emotion classification model and the emotion of the user may be second-classified by means of a classification unit of the emotion classification model.

For example, further referring to FIG. 4C, in the step S430 of recognizing an emotion of the user with respect to the content, new biosignal data 432 is input to the feature part 434 of the emotion classification model 430. Thereafter, the new biosignal data 432 is input to the feature part 434 and then output as a predetermined emotion, and a class of the emotion may be first-classified on the basis of the emotion output value. Next, the first-classified emotion class is input to the classification unit 436. Next, the emotion of the user is second-classified to be output. For example, the new biosignal data 432 may be finally classified and output as happiness 438 by the classification unit 436 and the emotion of the user with respect to the content may be recognized as happiness.

At this time, the emotion classification model 430 may be configured to connect the classification unit to the feature part 434 and a feature part which learns the configuration between the classified classes one more time. Therefore, the emotion classification model 430 classifies the emotion more precisely on the basis of the additionally trained feature part and the classification unit and may provide an emotion recognition result with a high reliability.

In the meantime, the feature part 434 and the classification unit 436 may be configured by a plurality of layers of (Convolution+Relu+Pooling)+[Feature Map]+Fully connected+Softmax+[Predicted probability compute]. According to the structural characteristic, the emotion of the biosignal data is first-classified on the basis of the trained feature part 434 and second-classified by the classification unit 436. However, the structure of the feature part 434 and the classification unit 436 for recognizing the emotion is not limited thereto.

For example, the emotion classification model is not limited to those described above, but may be a model based on at least one deep learning algorithm among a deep neural network (DNN), a convolutional neural network (CNN), a deep convolutional neural network (DCNN), a recurrent neural network (RNN), a restricted Boltzmann machine (RBM), a deep belief network (DBN), and a single shot detector (SSD) model.

According to the above-described procedure, the emotion recognition device according to the exemplary embodiment of the present invention based on the emotion classification model may provide an emotion recognition result of the user on the basis of the bio signal data of the user acquired from the HMD device.

The device and the method according to the exemplary embodiment of the present invention may be implemented as a program command which may be executed by various computers to be recorded in a computer readable medium. The computer readable medium may include solely a program command, a data file, and a data structure or a combination thereof.

The program commands recorded in the computer readable medium may be specifically designed or constructed for the present invention or those known to those skilled in the art of a computer software to be used. Examples of the computer readable recording medium include magnetic media such as a hard disk, a floppy disk, or a magnetic tape, optical media such as a CD-ROM or a DVD, magneto-optical media such as a floptical disk, and a hardware device which is specifically configured to store and execute the program command such as a ROM, a RAM, and a flash memory. Further, the above-described medium may be a transmission medium such as optical or metal wire or a waveguide including a carrier wave which transmits a signal specifying a program commands or data structures. Examples of the program command include not only a machine language code which is created by a compiler but also a high level language code which may be executed by a computer using an interpreter.

The above-described hardware device may operate as one or more software modules in order to perform the operation of the present invention and vice versa.

Although the exemplary embodiments of the present disclosure have been described in detail with reference to the accompanying drawings, the present disclosure is not limited thereto and may be embodied in many different forms without departing from the technical concept of the present disclosure. Therefore, the exemplary embodiments of the present disclosure are provided for illustrative purposes only but not intended to limit the technical concept of the present disclosure. The scope of the technical concept of the present disclosure is not limited thereto. Therefore, it should be understood that the above-described exemplary embodiments are illustrative in all aspects and do not limit the present disclosure. The protective scope of the present disclosure should be construed based on the following claims, and all the technical concepts in the equivalent scope thereof should be construed as falling within the scope of the present disclosure.
100: Emotion recognition device
200: HMD device
312: First labeled brain wave data
314: Second labeled brain wave data
310′, 310″: Encoder
320′: Feature part z
320″: Feature part \hat{z}
330′, 330″: Decoder
332′, 332″: Reconfigured labeling brain wave signal data
340: Update unit
430: Emotion classification model
432: New biosignal data
434: Feature part
436: Classification unit
438: Happiness
1000: Emotion recognition system

What is claimed is:

1. An emotion recognition method implemented by a processor, comprising:
providing content to a user;
receiving biosignal data of the user while the content is being provided; and
recognizing an emotion of the user with respect to the content by using an emotion classification model trained to classify emotions on the basis of a plurality of biosignal data labeled with emotions,
wherein the plurality of labeled biosignal data includes first labeled biosignal data matching the emotion of the user and second labeled biosignal data of the biosignal data which has a lower labeling reliability than that of the first labeled biosignal data or does not match the emotion of the user.

2. The emotion recognition method of claim 1, wherein the emotion classification model is a model trained by:
receiving at least one of labeled biosignal data between the first labeled biosignal data and the second labeled biosignal data;
encoding the at least one of received labeled biosignal data;
decoding the at least one of encoded labeled biosignal data so as to acquire reconfigured biosignal data; and
training a feature part determined by the classification model to minimize a difference between the at least one of received labeled biosignal data and the reconfigured biosignal data.

3. The emotion recognition method of claim 2, wherein the feature part includes a first feature part including a feature variable with respect to the first labeled biosignal data and a second feature part including a feature variable with respect to the second labeled biosignal data,
wherein training the feature part includes:
comparing feature variables of the first feature part and the second feature part; and
updating the feature variable of the second feature part to the first feature part on the basis of a comparison result.

4. The emotion recognition method of claim 3, wherein there is a plurality of user's emotions,
the first feature part includes a feature variable with respect to each of the plurality of user's emotions, and
the second feature part includes at least one feature variable, among a feature variable for each of the plurality of emotions, a feature variable with respect to two or more combined emotions selected from the plurality of emotions, and a feature variable with respect to an emotion different from the plurality of emotions.

5. The emotion recognition method of claim 2, further includes repeating:
receiving the at least one of labeled biosignal data;
encoding the at least one of biosignal data;
decoding the at least one of encoded biosignal data, and
training the feature part.

6. The emotion recognition method of claim 2,
wherein encoding the at least one of labeled biosignal data includes:
encoding to extract a feature variable with respect to the at least one of labeled biosignal data, and
the emotion recognition method further comprising:
after encoding the at least one of labeled biosignal data, determining the feature part on the basis of the extracted feature variable.

7. The emotion recognition method of claim 2, wherein recognizing the emotion of the user with respect to the content includes:
classifying the emotion of the user with respect to the content on the basis of the biosignal data of the user, by means of the feature part.

8. The emotion recognition method of claim 2, wherein the emotion classification model further includes:
a classification unit connected to the feature part, and
wherein recognizing the emotion of the user with respect to the content includes:
first-classifying the emotion of the user with respect to the content on the basis of the biosignal data of the user, by means of the feature part; and
second-classifying the emotion of the user with respect to the content, by means of the emotion classification unit.

9. The emotion recognition method of claim 1, further comprising:
labeling a biosignal acquired from the user on the basis of the emotion of the user so as to acquire labeled biosignal data, before providing content to a user.

10. The emotion recognition method of claim 9, wherein labeling on the basis of the emotion of the user includes:
providing emotion inducing content to the user;
receiving biosignal data of the user while the emotion inducing content is being selected;
receiving selection on the emotion inducing content; and
matching the selection and the biosignal data so as to acquire the labeled biosignal data.

11. The emotion recognition method of claim 10, further comprising:
receiving gaze data with respect to the emotion inducing content,
wherein the selection includes staring on at least one content selected from the emotion inducing contents.

12. The emotion recognition method of claim 11, when the staring is maintained for a predetermined time or longer, wherein matching the biosignal data includes:
matching the selection and the biosignal data as first labeled biosignal data, and
when the staring is maintained shorter than a predetermined time, wherein matching the biosignal data includes:
matching the selection and the biosignal data as second labeled biosignal data,

13. The emotion recognition method of claim 1, wherein the biosignal data is at least one of brain wave data and gaze data of the user.

14. An emotion recognition device, comprising:
an output unit configured to provide content to a user;
a receiver configured to receive biosignal data of the user while the content is being provided; and
a processor connected to communicate with the receiver and the output unit,
wherein the processor is configured to recognize an emotion of the user with respect to the content by using an emotion classification model trained to classify emotions on the basis of a plurality of biosignal data labeled with emotions, and
the plurality of labeled biosignal data includes first labeled biosignal data matching the emotion of the user and second labeled biosignal data of the biosignal data which has a lower labeling reliability than that of the first labeled biosignal data or does not match the emotion of the user.

15. The emotion recognition device of claim 14, wherein the emotion classification model is a model trained by:
receiving at least one of labeled biosignal data between the first labeled biosignal data and the second labeled biosignal data; encoding the at least one of received labeled biosignal data; decoding the at least one of encoded labeled biosignal data so as to acquire reconfigured biosignal data; and training a feature part determined by the emotion classification model to minimize a difference between the at least one of received labeled biosignal data and the reconfigured biosignal data.

16. The emotion recognition device of claim 15, wherein the feature part includes a first feature part including a feature variable with respect to the first labeled biosignal data and a second feature part including a feature variable with respect to the second labeled biosignal data, and is configured to compare the feature variables of the first feature part and the second feature part and update the feature variable of the second feature part to the first feature part on the basis of a comparison result.

17. The emotion recognition device of claim 16, wherein there is a plurality of user's emotions,
the first feature part includes a feature variable with respect to each of the plurality of user's emotions, and
the second feature part includes at least one feature variable, among a feature variable for each of the plurality of emotions, a feature variable with respect to two or more combined emotions selected from the plurality of emotions, and a feature variable with respect to an emotion different from the plurality of emotions.

18. The emotion recognition device of claim 15, wherein the emotion classification model is a model trained by repeating: receiving at least one of labeled biosignal data; encoding the at least one of biosignal data; decoding the at least one of encoded biosignal data; and training the feature part.

19. The emotion recognition device of claim 15, wherein the emotion classification model is further configured to encode the at least one of labeled biosignal data so as to extract a feature variable with respect to the at least one of labeled biosignal data, and
wherein the feature part is determined on the basis of the extracted feature variable.

20. The emotion recognition device of claim 15, wherein the feature part is further configured to classify the emotion of the user with respect to the content on the basis of the biosignal data of the user.

21. The emotion recognition device of claim 15, wherein the emotion classification model further includes a classification unit which is connected to the feature part and is configured to classify an emotion of the user with respect to the content on the basis of an output value of the feature part.
